(19) United States
(12) Patent Application Publication
(10) Pub. No.: US 2012/0326502 A1
(43) Pub. Date: Dec. 27, 2012

(54) SYSTEM AND METHOD OF ELIMINATING WASTED ENERGY KNOWN AS VAMPIRE ELECTRICITY OR PHANTOM LOAD LOSS

(76) Inventors: Hap NGUYEN, Fountain Valley, CA (US); John J. FISCHER, Marietta, GA (US); Tinh H. HOANG, Westminster, CA (US)

(21) Appl. No.: 13/533,052

(22) Filed: Jun. 26, 2012

Related U.S. Application Data
(60) Provisional application No. 61/571,401, filed on Jun. 27, 2011.
(60) Provisional application No. 61/574,793, filed on Aug. 10, 2011.
(60) Provisional application No. 61/632,367, filed on Jan. 23, 2012.

(51) Int. Cl. H02J 7/34

(52) U.S. Cl. 307/21

(57) ABSTRACT

An apparatus for eliminating electricity leakage from an electronic device connected to a power supply, while the electronic device is in switched-off or stand-by state is disclosed. The apparatus comprises of a charging module connected to at least one rechargeable battery for selectively providing electricity from the power supply to the rechargeable battery while the electronic device is in switched-on state. An isolation module is provided for isolating the power supply from the electronic device while the electronic device is in switched-off or standby state and restoring the power supply when the electronic device is in switched-on state. A back up module connected to the rechargeable battery, providing power to at least one active component from the rechargeable battery such that at least one active component remains operational even when the electronic device is in switched-off or standby state.

### CROSS REFERENCE TO RELATED APPLICATION

The present application claims the benefit of priority from U.S. Provisional Applications Ser. No. 61/571,401 filed Jun. 27, 2011, 61/574,793 filed on Aug. 10, 2011 and 60/632,367 filed on Jan. 23, 2012, which are herein incorporated with reference in their entireties.

### FIELD OF INVENTION

The present disclosure generally relates to consumer electronics and related equipment. In particular, the present disclosure relates to a method and apparatus for eliminating electricity leakage when the electronic device is in switched-off state or standby state.

### BACKGROUND

For decades, electronic and electrical appliance manufacturers throughout the world have engineered products, which continue to consume power even when they are switched off or not performing their primary function. This wasted energy is often referred to as standby power, phantom load, leaking electricity and vampire power. For consistency, these items will be referred as “vampire electronics.” Examples of Vampire Electronics” would be a cellular phone charger that still draws power even after the cellular phone battery reaching full charge, a coffeemaker with a clock that runs even when the machine is not in use, a DVD player with a display that always shows, a computer on standby or any other electronic device such as AC, refrigerator that consumes power when not performing their primary functions.

California Energy Department's scientists estimate that Vampire charging systems in California waste up to 60% of the electricity they suck from outlets. The wasted energy is enough to power 350,000 homes, equivalent to a city the size of Bakersfield.

Recent studies suggest almost 10% of all energy used in the United States goes toward standby power drain. With new consumer gadgets coming out all the time, that amount could reach 20% within three years. The World Health Organization estimates 5.2 billion people own a cellular phone. In the United States alone, upwards of $10 billion a year is spent to power electronic devices that aren't being used. In the average household, there are approximately 20 of these electronic devices ranging from cellular phone chargers, coffee makers, toasters with digital displays, microwave ovens, modems, wireless routers, cordless phones, desktop computers, notebook chargers, I pods, I pads, game consoles, printers, TVs, DVRs, cable boxes, stereos, receivers, low voltage track lights, etc.

FIG. 1 illustrates a block diagram of a conventional Flat Screen TV 10. On/off switch 12 is circuited behind power supply 14 and the remote controller module 16. Therefore, electricity is consumed by remote control receiver module 16 and power supply 14 even when the switch is in the off position. The remote control receiver 16 or other components such as sleep timer or clock are responsible for electricity leakage or adding extra consumption of electricity that reflects on the electricity bill. The rest of the electronic device such as tuner, receiver and video processing circuit 18, I/O circuit 20, display 22, audio processing circuit 24 and speaker 26 are powered when the electronic device is in switch-on state.

The International Energy Agency recently released a report estimating the amount of energy wasted by standby products each year to be between 200 and 400 terawatt hours. In comparison, the entire country of Italy consumes 300 terawatt hours of energy each year.

With skyrocketing energy costs, this has become a hot issue in recent years. In an attempt to address the issue, lawmakers in California even passed a law nicknamed Vampire Slayers. The law mandates adding labels to electronic products telling the consumer how much energy is consumed when the electronic device is on, off or in standby state. The law does not require any action from the manufacturers to address this problem. The quest to reduce the standby energy waste is the new regulation passed on Jan. 12, 2012 mandating new standard on chargers for mobile devices.

In order to obviate at least one or more of the aforementioned problems, there is a well-felt need to provide an improved method and apparatus for energy saving that at least reduces the consumption of power when the electronic devices is in switched-off state or standby state.

### SUMMARY

An apparatus for eliminating electricity leakage from an electronic device connected to a power supply, while the electronic device is in switched-off state or stand-by state is disclosed. The electricity leakage is the electricity consumed by at least one active component of the electronic device that remains active in the switched-off state or standby state. The apparatus comprises of a charging module connected to at least one rechargeable battery for selectively providing electricity from the power supply to the rechargeable battery while the electronic device is in switched-on state. An isolation module is provided for isolating the power supply from the electronic device while the electronic device is in switched-off state or standby state and restoring the power supply when the electronic device is in switched-on state. A back up module connected to the rechargeable battery, providing power to at least one active component from the rechargeable battery such that at least one active component remains operational even when the electronic device is in switched-off state or standby state.

The apparatus further comprises of a behavior scheduling module for smart scheduling of the electronic device such that the electronic device learns the utilization behavior or habits of a user and generate a scheduling configuration to schedule powering up of the electronic device prior to scheduled use.

According to an embodiment of the disclosure, the active components are a remote control receiver or a real time clock.

According to another embodiment of the disclosure, a plurality of components needed for working of the electronic devices is active when the electronic device is in switched-on state.

According to another embodiment of the disclosure, the isolation module may comprise of a diode configured to disconnect the power supply from the electronic device when the electronic device is in switched-off state or standby state.

According to another embodiment of the disclosure, the charging module may be configured for charging the rechargeable battery through the power supply in a switched-off state or standby state, if the charge of the rechargeable battery is below a predefined threshold.

According to another embodiment of the disclosure, the charging module may be configured for disconnecting the charging of the rechargeable battery in a switched-on state or switched-off state or standby state, once the rechargeable battery are completely charged.

According to another aspect of the disclosure, the apparatus further comprises of a charging controller, such that the charging controller comprises a timing and control IC for charging the electronic device based on one or more pre-specified protocols.

According to another embodiment of the disclosure, the charging controller comprises of a Microprocessor Unit (MPU), a Memory Module, a RAM Module, a Charging Protocol Table, Analog to Digital Module (A/D), an On/Off Switching Module and an Input/Output Module.

A method for eliminating electricity leakage from an electronic device connected to a power supply while the electronic device is in switched-off state or stand-by state is disclosed. The method comprises of isolating the power supply from the electronic device when the electronic device is in switched-off state or standby state. Further, power may be provided to at least one active component of the electronic device from at least one rechargeable battery such that at least one active component remains operational even when the electronic device is in switched-off state or standby state. Further, the rechargeable battery may be charged from the power supply as the electronic device is in switched-on state.

The method further comprises of restoring the power supply when the electronic device is in switched-on state.

The method further comprises of monitoring and controlling the charging of rechargeable batteries through a charging controller.

The method further comprises of smart scheduling of the electronic device such that the electronic device learns the utilization behavior or habits of an user and generating a scheduling configuration to schedule powering up of the electronic device prior to scheduled use.

### BRIEF DESCRIPTION OF FIGURES

To further clarify the above and other advantages and features of the present disclosure, a more particular description of the disclosure will be rendered with reference to specific embodiments thereof, which are illustrated in the appended drawings. It is appreciated that these drawings depict only typical embodiments of the disclosure and are therefore not to be considered limiting in their scope. The disclosure will be described and explained with additional specificity and detail with the accompanying drawings in which:

FIG. 1 illustrates a known simple block diagram of a typical flat screen TV;

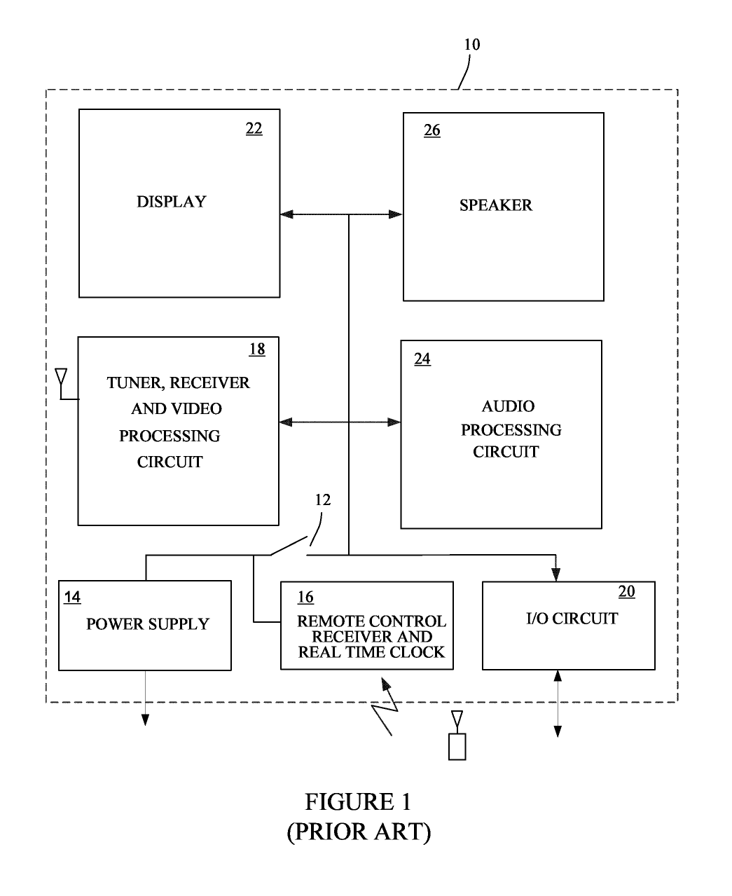

FIG. 2 illustrates an apparatus for eliminating electricity leakage from an electronic device connected to a power supply, while the electronic device is in switched-off state or stand-by state in accordance with an embodiment of the disclosure;

FIG. 3 illustrates a block diagram of an electronic device such as a flat screen TV with an apparatus for eliminating no-standby electricity loss in accordance with an embodiment of the disclosure;

FIG. 4 illustrates a simplified block diagram of an apparatus for eliminating standby electricity loss from plurality of electronic devices in accordance with an embodiment of the disclosure;

FIG. 5 illustrates a simple block diagram of an apparatus for eliminating standby electricity loss from an electronic device in accordance with an embodiment of the disclosure.

FIG. 6 illustrates a block diagram of no standby electricity loss of electronic equipment and appliance in accordance with an embodiment of the disclosure;

FIG. 7 illustrates a logic flow chart of energy adaptive in accordance with an embodiment of the disclosure;

FIG. 8 illustrates a logic flow chart of charging method in accordance with an embodiment of the disclosure; and

FIG. 9 illustrates a block diagram of an apparatus comprising of a charging controller in accordance with an embodiment of the disclosure.

### DETAILED DESCRIPTION

The disclosure herein creates a true standby off electronic device meaning there is no electricity leaking when the electronic device is switched off or in standby state. The technology is a method and apparatus of energy saving that isolate the minimal essential active components of an electronic device in one circuit when the electronic device is in standby state (not performing its primary function) or in switched-off state. The method and apparatus disconnects the electronic device from the power supply and powers the active components of the electronic device by a rechargeable battery. The method and apparatus continues to allow the active components such as remote control receiver and other wake up signals such as sleep timers or clock to remain completely functional while the electronic device is completely cut off from its primary source of power.

A method and apparatus to eliminate all phantom electricity load or standby power consumption from an electronic device when the electronic device is in switched-off state or standby state is disclosed herein. The method and apparatus uses zero standby power by combining functional engineering and re-routing circuits wherein no plugs are needed to be pulled, no switches to be switched off and the electronic device remains operational in switched-off state or standby state.

According to an aspect of the disclosure, the electronic device may be in switched-off state or standby state or switched-on state. In switched off state or standby state, the electronic device may disconnect from the power supply and shut down or go to sleep. However, a plurality of components of the electronic device may remain active such as a remote control receiver or a real time clock. These active components may consume electricity even while the electronic device is switched off or standby. These components may be responsible for electricity leakage or adding extra consumption of electricity that reflects on the electricity bill. The disclosure provides a method and apparatus for eliminating the electricity consumed by the above-mentioned active components of the electronic device when the electronic device is in switched-off state or standby state.

In switched-on state, all the components of the electronic device that are responsible for the working of the electronic device may be active and consume electricity from the power supply.

The method and apparatus relates to grouping at least one active component of an electronic device into one circuit, then powering the circuit with at least one rechargeable backup battery while the electronic device is in switched-off state or standby state. This combination of components will disconnect electronic device from a power supply such as a power grid, yet still allow remote control receivers or wake up functions such as sleep timers, etc to be operational.

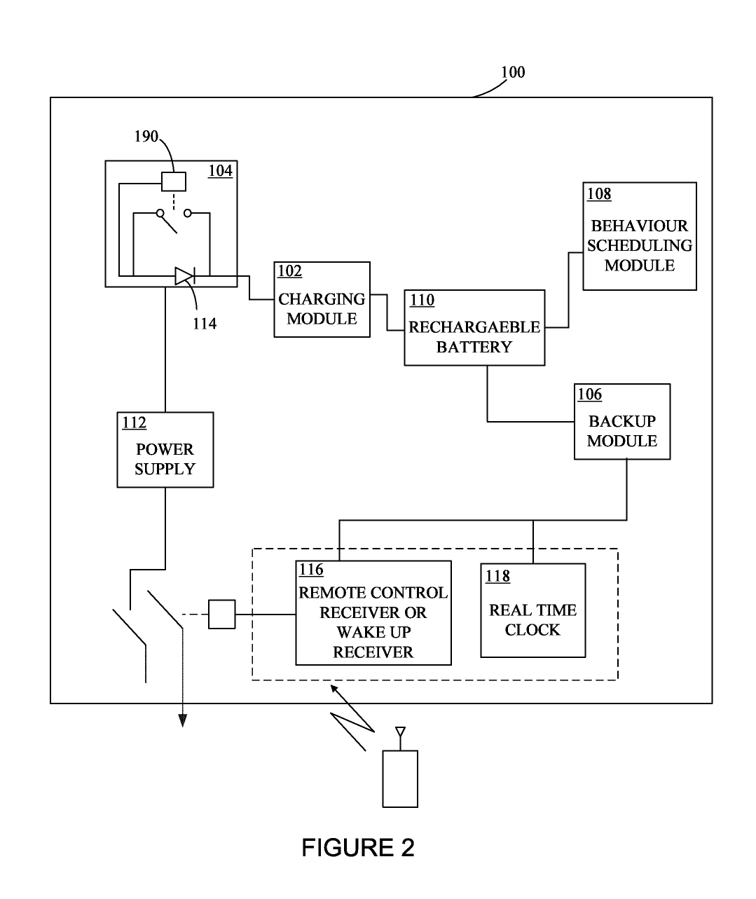

FIG. 2 illustrates an apparatus 100 for eliminating electricity leakage from an electronic device (not shown) connected to a power supply 112, while the electronic device is in switched-off state or stand-by state in accordance with an embodiment of the disclosure. The electricity leakage may be the electricity consumed by at least one active component of the electronic device (not shown) that remains active in the switched-off state or standby state. The apparatus 100 may comprise of a charging module 102, an isolation module 104, a backup module 106 and a behavior scheduling module 108.

The charging module 102 may be connected to at least one rechargeable battery 110 for selectively providing electricity from a power supply 112 to the rechargeable battery 110 while the electronic device is in switched-on state. The charging module 102 may be configured for recharging the rechargeable battery 110 as the electronic device is connected back to the power supply 112.

The isolation module 104 may be configured to isolate the power supply 112 from the electronic device while the electronic device is in switched-off state or standby state and restore the power supply 112 when the electronic device is in switched-on state. The isolation module 104 may comprise of a diode 114 or relay 190 (diode 114 or relay 190 is isolation module) configured to disconnect the power supply 112 from the electronic device when the electronic device is in switched-off state or standby state.

The charging module 102 may be further configured for charging the rechargeable battery 110 through the power supply 112 in a switched-off state or standby state, if the charge of the rechargeable battery is below a predefined threshold.

The charging module 102 may be configured for disconnecting the charging of the rechargeable battery 110 in a switched-on state or switched-off state or standby state, once the rechargeable battery 110 are completely charged.

The back up module 106 may be connected to the rechargeable battery 110 for providing power to at least one active component from the rechargeable battery 110 such that at least one active component may remain operational even when the electronic device is in switched-off state or standby state. The active components herein may be a remote control receiver 116 or a real time clock 118.

The behavior scheduling module 108 may be configured for smart scheduling of the electronic device such that the electronic device learns the utilization behavior or habits of an user and may generate a scheduling configuration to schedule powering up of the electronic device prior to scheduled use.

### EXAMPLE

A microwave oven may be awakened and powered by a switch mounted in the door when it is open. Once the cooking is finished the microwave may go back to a standby state. After a predetermined period, the microwave may turn off the display and other non-essential components. With a real time clock already built in the microwave and with proper software, the microwave may learn the daily using habit of the first few weeks of operation and then adapt the best energy saving schedule and mode that may save even more energy during idle periods. The cumulative effect may be incredible energy savings, reduction of wattage consumed, lessening the world's carbon footprint and effectively creating a greener planet.

According to an aspect, the apparatus 110 may be a stand-alone electronic device or may be integrated with any conventional electronic devices.

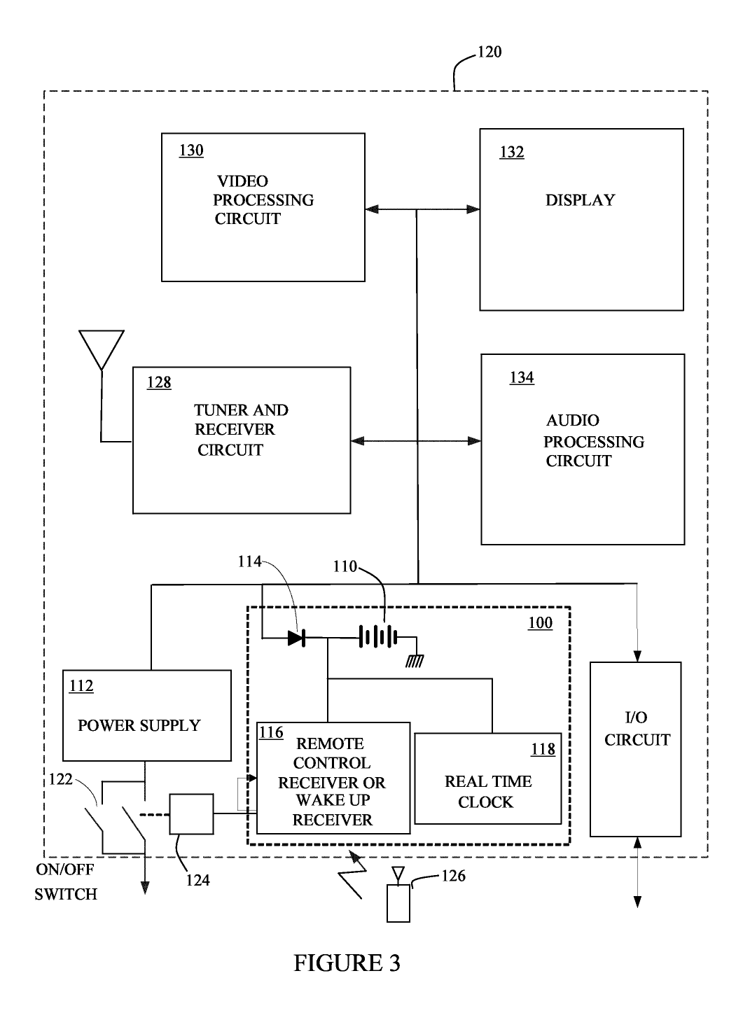

FIG. 3 illustrates a block diagram of an electronic device 120 such as a flat screen TV with an apparatus 100 for eliminating no-standby electricity loss in accordance with an embodiment of the disclosure. An on/off switch 122 may be wired between a power supply 112 and a power cord (not shown). Therefore, there may be no electricity drawn when the switch 122 and a relay 124 are in the OFF position. When the switch is in the ON position, electricity may be applied to the power supply 112 which supplies needed voltages for various circuits of the electronic device 120. The power required for the remote control receiver 116 or other trigger signal and real time clock 118 may be provided via diode 114. According to an embodiment, the diode 114 also supplies a charging voltage to charge a rechargeable battery 110. Diodes 114 may also serves as an isolator diode that isolates the rest of the components of the electronic device 120 from an apparatus 100 for preventing electricity leakage when the electronic device 120 is in switched off state or standby state.

The apparatus 100 also includes a charging and isolation module (not shown in this FIG. 3) and related circuit, rechargeable battery 110, active components such as remote control receiver or wake up receiver 116 and real time clock 118 and a backup module (not shown in FIG. 3). This apparatus 100 may allow the electronic device 120 to switch off and disconnect from the power supply via the isolation module while remaining operational by the backup module (not shown in FIG. 3). The backup module may comprise of a relay 124 to provide power to the active components of the electronic device via the rechargeable battery 110.

Remote control receiver link signal may be from a remote controller 126. The signal may be wireless or wired signal. The rest of the electronic device 120 such as tuner & receiver circuit 128, video processing circuit 130, display 132 and audio processing circuit 134 are powered when the switch 122 is in switched on position or relay 124 is energized by the remote controller 126.

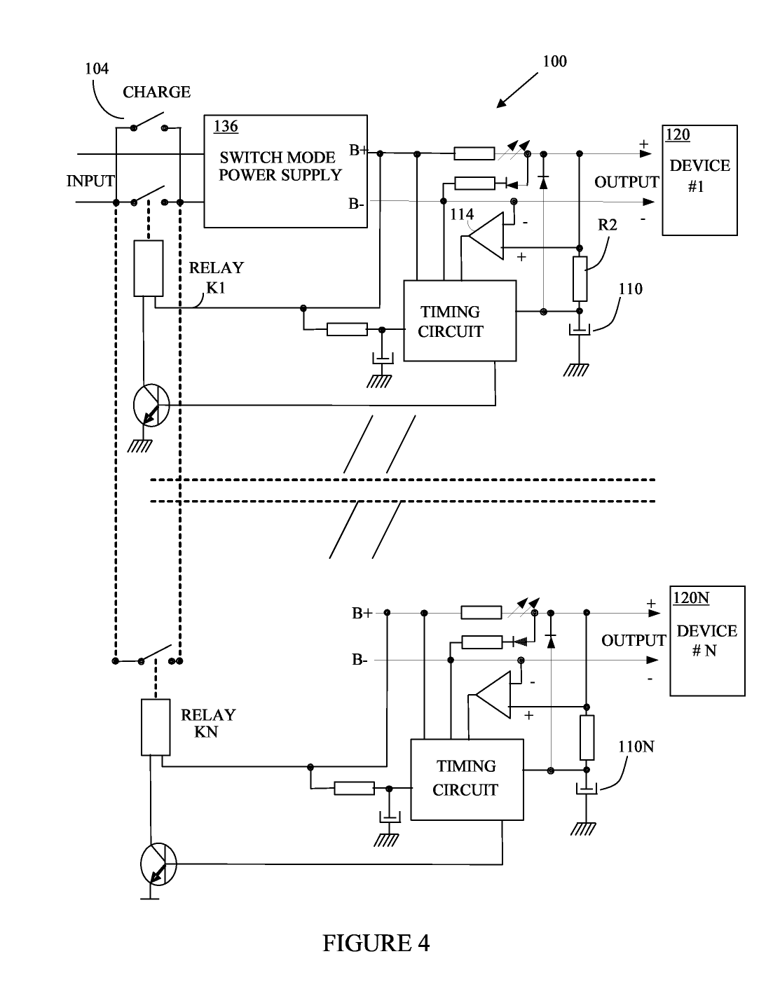

FIG. 4 illustrates a simplified block diagram of an apparatus 100 for eliminating standby electricity loss from plurality of electronic devices in accordance with an embodiment of the disclosure. In this embodiment of the disclosure, the apparatus 100 is illustrated as a stand-alone electronic device positioned in direct communication with a plurality of electronic devices.

FIG. 4 illustrates a plurality of electronic devices such as electronic device 120 and electronic device 120N. The electronic device 120N may draw power from switch mode power supply 136 of electronic device 120 as illustrated in FIG. 4. According to an alternate embodiment, the electronic device 120N may draw power from its own power supply (not shown) also. The circuit of electronic device 120N may be identical to electronic device 120, however only one switch mode power supply 136 may be used. When the charging switch 104 is switched on, the apparatus 100 will turn on (due to the operation of the current sensing feature) if one or more electronic devices 120 to 120N to be charged are plugged in. The apparatus 100 may also be activated automatically when any electronic device 120 to 120N in the charging circuit does not have a full charge. Once the plugged in electronic devices 120 to 120N reach their full charge, the apparatus 100 may disconnect itself from power grid. Relay K1 to KN contacts may be wired in parallel with the charge switch. According to another embodiment, the Relay K1 may be a small TRIAC for low power usage electronic device up to a heavy-duty mercury relay for industrial chargers such as forklift chargers or electric vehicle chargers.

According to an aspect of the disclosure, when an under-charged electronic device is plugged in, the residual power of the electronic device powers a control circuit automatically. A trigger signal initiates a charging timing cycle. Once the charging timing cycle is timed out or the electronic device is fully charged, the control circuit automatically turns off and disconnects the electronic device from the power grid. This action eliminates standby energy.

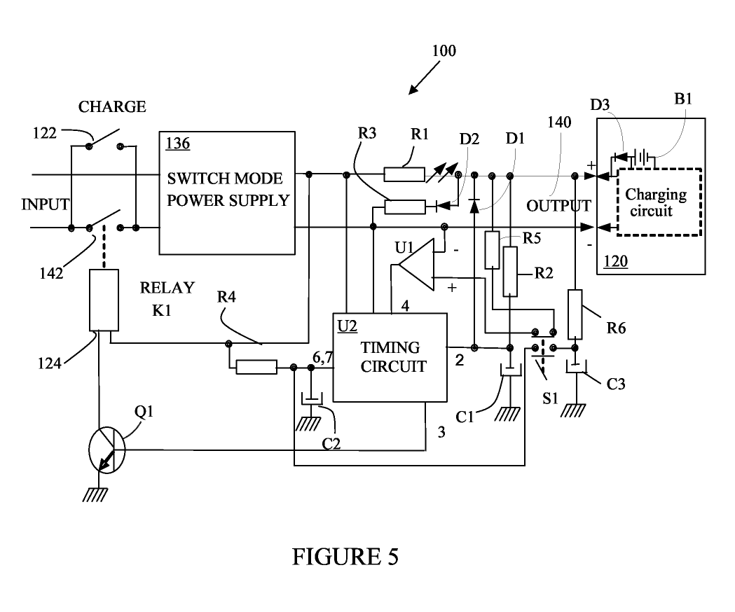

FIG. 5 illustrates a simple block diagram of an apparatus 100 for eliminating standby electricity loss from an electronic device 120 and apparatus 100 in accordance with an embodiment of the disclosure. According to this embodiment, the charging switch 122 and the relay contact 142 may be normal OFF. Electronic devices such as a typical cellular phone, laptop computer or small electronic appliance may use a switch mode power supply 136 which may be always ON even when the electronic device 120 reaches full charge because no on/off button is provided. To initiate the charging process in such electronic devices, the electronic device 120 may be plugged in output jack 140 of the apparatus 100 for charging the electronic device 120. The power required for the timing and control circuits may be fed from the electronic device 120 battery B1 via diode D3, which powers the timing and control circuits. Diode D3 isolates the battery B1 from the output jack 140. According to an embodiment, the residual power in electronic device 120 may not have to be significant as the timing and control circuits only require just a fraction of a second to latch relay K1. The operating and charging voltage appears at output + and − jack 140. The output jack 140 feeds the power to the timing and control circuit and a LOGIC LOW generating signal at the pin 2 of a U2 due to the C1 being charged via R2, triggering the charging cycle. Diode D1 may be a fail-safe component to ensure complete charging cycle every time the electronic device 120 is plugged in to the apparatus 100 to be charged. U2 is a 555 timer IC as illustrated in the FIG. 5; however any timing circuit or timing software may be used. Output at pin 3 becomes a logic HIGH, switching on transistor Q1, energizing relay K1, closing N.O. contact 142 which makes the power supply 136 stay on at the predetermined cycle. Resistor R4 and capacitor C2 may provide time constant that determines the timing cycle.

According to another embodiment, the timing cycle may be customized for different electronic devices to meet the charge requirement of that particular electronic device. When the ON time duration as determined by time constant of resistor R4 and capacitor C2 fed to pin 6 and 7 of timing IC U2 is timed out, the relay K1 124 N.O. contact 142 shall open, thereby turning the charging off. The apparatus 100 works even more efficiently with an automatic full charge turn off circuit, resistor R1. Resistor R1 may be a current sensing resistor providing a full charge condition signal to comparator control IC U1. Control IC U1 may send a turn off signal to the timing IC U2 and may reset signal at pin 4 to turn off the relay K1. Resistor R5 may be a reference resistor for control IC U1. The relay K1 contact may be open, disconnecting the apparatus 100 from the power grid. Resistor R3 and LED diode D2 may provide a visual pilot indicating the charger is ON.

Typically the new batteries from electronic device manufacturers may be required to initially charge from 8 to 16 hours at first use. According to an embodiment, a switch S1 may be provided to perform this initial charging of the rechargeable batteries. The switch S1 may be a DPDT switch (double pole double throw switch) that disconnects resistor R5 reference resistor of the current sensing circuit and adds additional components for an RC time constant circuit with capacitor C3 and resistor R6 increasing the duration of charging time.

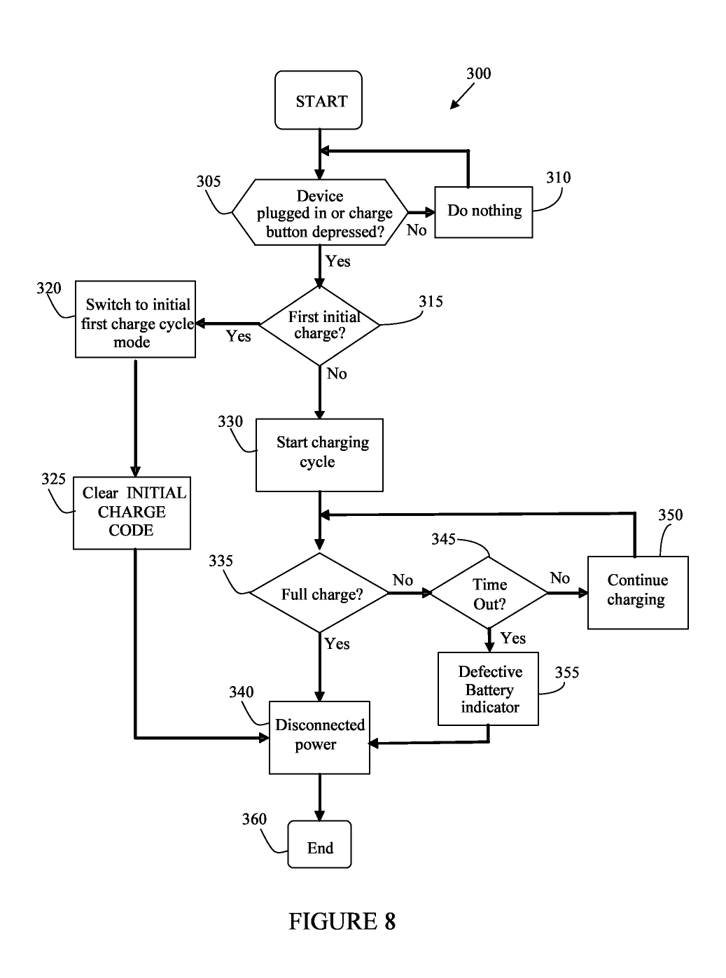

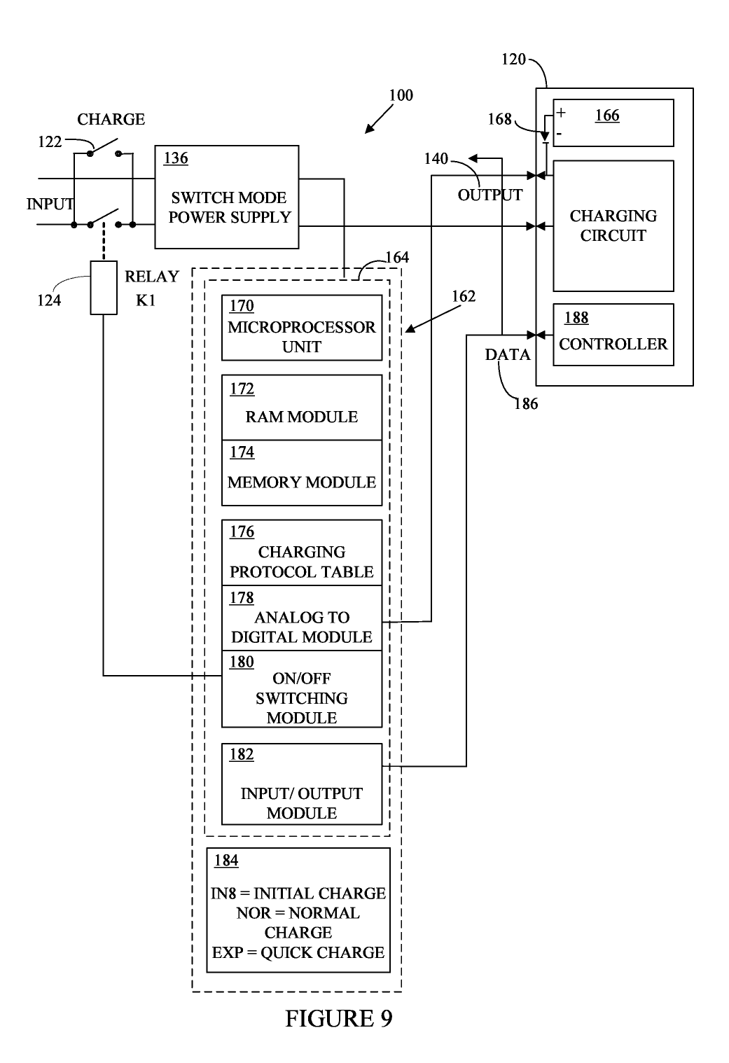

An alternative option is to provide a micro controller based apparatus 100 and a battery with a FIRST INITIAL CHARGE code factory embedded as illustrated in FIG. 9. The intent of the FIRST INITIAL CHARGE CODE is to establish the understanding that the battery has not yet undergone the manufacturer set initial timing charge needed for optimal battery life. The apparatus 100 may check for the FIRST INITIAL CHARGE CODE (A worldwide standardized code needs to be established in this regard). If the checking procedure indicates FIRST INITIAL CHARGE CODE signaling the battery has not undergone the first initial charge, then the FIRST INITIAL CHARGE cycle will be activated as illustrated in FIG. 8.

In the event the electronic device 120 is completely exhausted, the switch button 122 gives momentary ON state providing the power to switch mode power supply 136 that provides necessary power to the timing IC U2 and control IC U1 as mentioned previously.

According to an embodiment, the relay K1 may be mechanical or solid state. The switch mode power supply 136 is used as an embodiment in the description. According to another embodiment, a linear power supply may also be used.

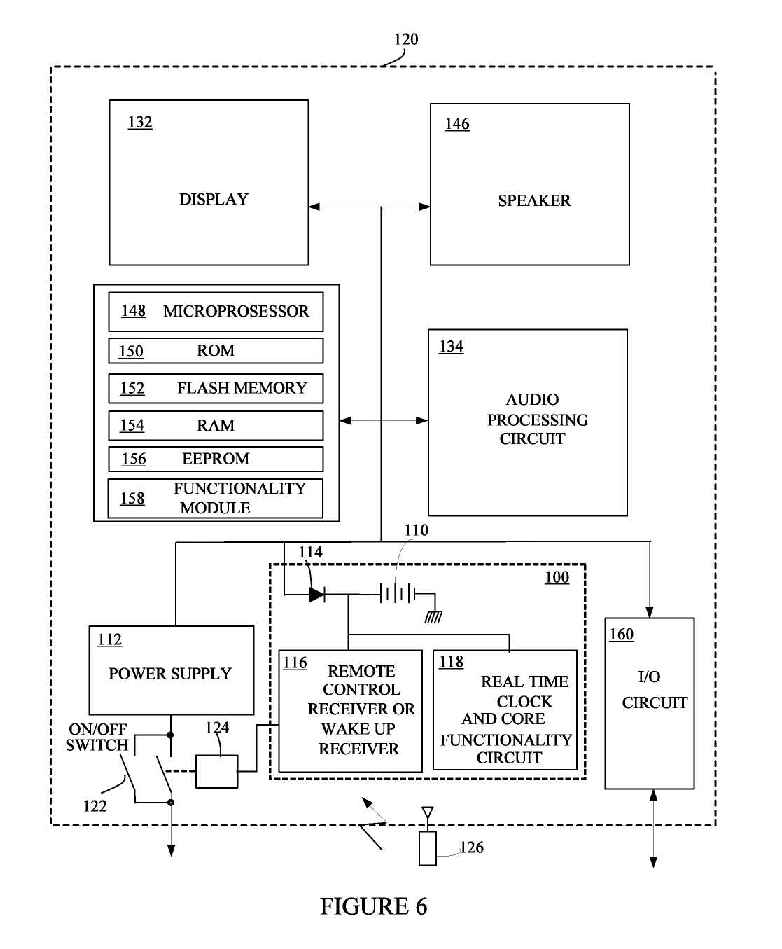

FIG. 6 illustrates a block diagram of an electronic device 120 in accordance with an embodiment of the disclosure. The electronic device 120 may correspond to large appliances such as microwave ovens, coffee makers, TVs, DVRs, Receivers, modems, wireless routers, cable boxes, satellite receivers and other electronic devices which consume electricity while in standby state and small electronic devices such as cellular phones, smart phones, personal digital assistants (PDAs), mobile paging devices, mobile gaming devices, net books, net pads, laptops, or other computer devices that utilize a rechargeable battery and battery charger and or a remote control receiver to recharge the electronic device battery when its battery is exhausted to bring back to operational state. The electronic device 120 typically includes at least one processing unit such as a microprocessor 148 and system memory such as ROM 150, Flash Memory 152, RAM 154 and EEPROM 156. Depending on the configuration and type of electronic device, for example a mobile phone may have volatile memory (such as RAM), non-volatile memory (such as ROM, flash memory, etc.), or some combination of the two, system memory typically includes an operating system; one or more program functionality modules 158, and may include program data. The microprocessor 148 may access the ROM memory 150 to execute instructions or applications stored as functionality modules 158 to perform one or more predetermined functions.

The functionality module 158 may include energy saving management information stored in memory 152, 156. In addition, electronic device 120 may also includes a built-in speaker 146 and audio processing module 134. It may be appreciated that the electronic device 120 may have various features available in all modern electronics and appliances. Only a select few of the features, functionalities, and modules have been disclosed that find relevance with respect to the ongoing description. For example, the electronic device 120 may also have an input device(s) 160 such as keypad, stylus, or a pen, voice input device, touch input device, ethernet, etc, as illustrated in FIG. 6. Output device(s) such as a display 132, speakers 146, etc. may also be included. The display 132 may be a liquid crystal display, or any other type of display commonly used in electronic devices 120. The display 132 may be touch-sensitive, and would then act as an input device. The electronic device 120 also includes remote control receiver configured to detect and turn on and other function command from a remote control 126. Such electronic devices 120 are well known in the art and are incorporated herein as reference.

The apparatus 100 for eliminating standby electricity loss according to an embodiment of the present disclosure may be used with one or more of the electronic device 120 as discussed above or any other electronic device without going beyond the scope of disclosure. The apparatus 100 includes a charging and isolation module (not shown in FIG. 6) and related circuit, rechargeable battery 110, active components such as remote control receiver or wake up receiver 116 and real time clock circuit 118 and back up module (not shown in FIG. 6). The apparatus 100 allows the electronic device 120 to turn off and disconnect from the power grid while via relay 124. Remote control 126 signal can be wireless or wired signal.

The electronic device 120 includes non-volatile storage EEPROM 156. The non-volatile storage may be used to store persistent and configuration information which should not be lost if the electronic device 120 is powered down/off such as best mode or schedule of operation as instructed by functionality module 158. The electronic device 120 includes a power supply 112. The power supply 112 might further include an external power source, such as an AC adapter or a powered docking cradle that supplements or recharges the batteries. A manual ON/OFF 122 may be wired before the power supply 112 for manual operation if desired.

According to an embodiment, the apparatus 100 further comprises of a behavior scheduling module 108 (as shown in FIG. 2) configured for smart scheduling of the electronic device such that the electronic device learns the utilization behavior or habits of an user and generate a scheduling configuration to schedule powering up of the electronic device prior to scheduled use.

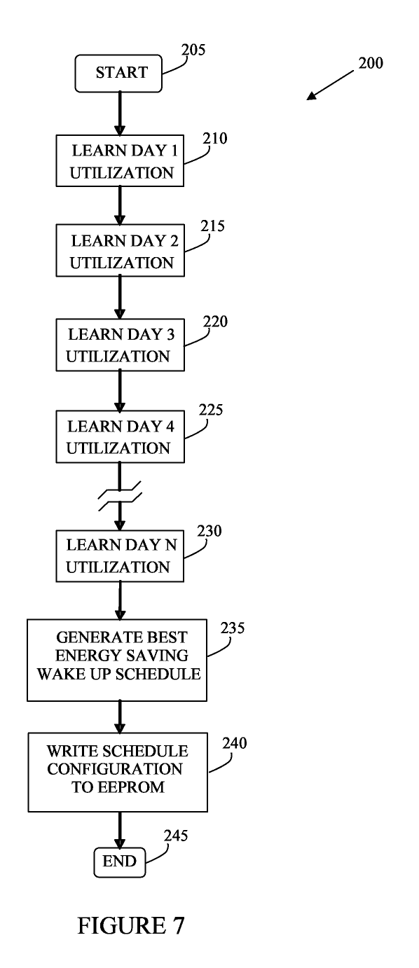

FIG. 7 illustrates the logic flow chart 200 of energy saving wake up schedule according to another embodiment of the disclosure, when an electronic device is first used at step 205, the apparatus 100 (FIG. 2) initiates a learning of utilization habit of the user from steps 210-230 for the specific number of day. According to an exemplary embodiment, the learning of utilization habit of the user may be monitored for the first 14 days of usage. According to another embodiment, the monitoring may be performed for any length determined by N in step 230. The apparatus 100 logs the user's habit by recording time of the electronic device in use and the idle time through out the consecutive total days. The apparatus 100 may generate a best energy saving wake up schedule as shown in the step 235. The apparatus 100 may further, write the scheduled configuration to a memory of the electronic device, as shown in step 240 to schedule powering up of the electronic device prior to scheduled use.

According to a specific example, if the electronic device is a coffee maker, then the learning program will collect patterns such as being used at specific time say for example at 6:00 am for 15 minutes (Monday till Friday) and at 8:00 am for 15 minutes on (Saturday and Sunday) in 14 consecutive days. The apparatus will further generate a scheduling configuration and write the same into EEPROM. Further, the electronic device will wake up at 5:50 AM ready to be used and go into sleep state in 5 minutes after being used on weekdays. On weekends, the electronic device will wake up at 7:50 AM and go into sleep state 5 minutes after being used. This energy saving scheduling may be used in-conjunction with circuit design that groups wake up and remote control circuit into a battery backup circuit that will eliminate standby electricity loss.

It is understood the discussed coffee maker example above is for the purpose of explanation the art of this apparatus; however this method can be applied to any microprocessor based electronic device, equipment or appliance that has a standby state utilizing an AC power source.

FIG. 8 illustrates a logic flow chart 300 of charging method in accordance with an embodiment of the disclosure. The flow chart 300 illustrates a start module of the charging method showing the charger in standby state with no power drawn because no electronic device is connected and the CHARGE BUTTON is not pressed. The start module will do nothing as shown in step 310 and may continuously scan for an electronic device or CHARGE BUTTON signal as shown in step 305. If no signal is found, the start module will remain inactive. When the start module detects an electronic device, the start module automatically checks for FIRST INITIAL CHARGE CODE as shown in step 315. If found, the start module switches to FIRST INITIAL CHARGE CYCLE MODE as shown in step 320, the start module further clears the FIRST INITIAL CHARGE CODE as shown in step 325, making all future charges as standard charges. When the FIRST INITIAL CHARGE CODE is absent, the charging cycle will begin as shown in step 330. Further, the charging status of the battery is checked at step 335. If the cycle indicates full charge, the start module will be disconnected from the power as shown in step 340 and the charging cycle will end at step 360. If the cycle indicates the charge is not full, the start module initiates time out as shown in step 345. Time out 345 checks if the manufacturer's set charging time is being satisfied or not. If manufacturer set charging time has not yet been satisfied, then the staring module continues charging at step 350. If the manufacturer set charging time is being met and the battery does not indicate being fully charged, the path will follow to step 355 to signal user that the battery may be defective because of passing the charging time period specified by the battery manufacturer and the charge being not full. Once the battery reaches full charge, the decision to disconnect it from the power is carried out at step 340, to end the process at step 360.

FIG. 9 illustrates a block diagram of an apparatus comprising of a charging controller in accordance with an embodiment of the disclosure. Electronic devices 120 such as cellular phone, laptop computer, etc. . . . comprise of a switch mode power supply 136 which may be NORMALLY ON even when the electronic device reaches full charge because no power cut-off component is provided. A charge button 122 and a relay contact 124 are always off for this embodiment of the disclosure.

To initiate the charging process, the electronic device 120 may be plugged in an output jack 140 of an apparatus 100 for charging the electronic device 120. The apparatus 100 may comprise of a charging controller 162 such that the charging controller 162 comprises of a timing and control IC 164 for charging the electronic device 120 according to pre-specified circumstances such as initial charge, normal charge or quick charge.

The power required for the timing and control IC 164 may be fed from the rechargeable battery 166 via DIODE 168. This residual power in electronic device 120 may not have to be significant according to this embodiment. The timing and control IC 164 only requires just a fraction of a second to latch relay K1. The operating and charging voltage appears at output + and − output jack 140 which provides needed power for the apparatus 100.

The timing and control IC 164 may comprise of a Microprocessor Unit (MPU) 170, a RAM Module 172, a Memory Module 174, a Charging Protocol Table 176, an Analog to Digital Module 178, an On/Off Switching Module 180 and an Input/Output Module 182.

The Microprocessor Unit 170 may be configured to access a charging code 184 of the rechargeable battery 166 from the electronic device 120 or/and the rechargeable battery 166 and uses the charging protocol processed by RAM and MEMORY module 172, 174. The charging code 184 may be IN8=Initial Charge, NOR=Normal Charge and EXP=Quick Charge, etc. According to a specific example of the disclosure, new batteries from electronic device manufacturers may be required to initially charge from 8 to 16 hours prior to first use of the electronic device. Code IN8 may be used as the electronic device is charged for the first time. Other codes may also be provided.

A DATA pin 186 may be the gateway to communicate with a controller 188 of the electronic device 120. The controller 188 may be a control PCB (Printed Circuit Board) of the electronic device 120. This may make future charging protocol updation possible via the under-charge electronic device 120. In the event, an electronic device 120 is completely exhausted, charge switch 122 gives momentary ON state providing the power to switch mode power supply 136 that provides necessary power to the timing and control IC 164 and the rest of the electronic device. Other modules of the timing and control IC 164 are Analog to Digital Module 178, for sensing the input current of the charging voltage; ON/OFF switching Module 180 to automatically turn a charging electronic device ON/OFF and Input/Output Module 182 configured to communicate with electronic device undercharged to use its transceiver for over the air communication for software update or to monitor the charging status or condition of the rechargeable battery of the undercharged electronic device.

According to another embodiment, a method for eliminating electricity leakage from an electronic device connected to a power supply while the electronic device is in switched-off state or stand-by state is disclosed. The method comprises of isolating the power supply from the electronic device when the electronic device is in switched-off state or standby state. Further, power may be provided to at least one active component of the electronic device from at least one rechargeable battery such that at least one active component remains operational even when the electronic device is in switched-off state or standby state. Further, the rechargeable battery may be charged from the power supply as the electronic device is in switched-on state.

The method further comprises of restoring the power supply when the electronic device is switched-on state. The method may further comprise of monitoring and controlling the charging of rechargeable batteries through a charging controller.

The method may further comprises of smart scheduling of the electronic device such that the electronic device learns the utilization behavior or habits of a user and generating a scheduling configuration to schedule powering up of the electronic device prior to scheduled use.

The apparatus and method, as disclosed above, shall improve billions of battery charging electronic devices along with a vast array of other electronic devices such as cellular phones, coffee makers, toasters with digital displays, microwave ovens, modems, wireless routers, cordless phones, desktop computers, notebook chargers, Ipods, Ipads, game consoles, printers, TV's, DVR's, cable boxes, stereos, receivers, low voltage track lights, etc.

While specific language has been used to describe the disclosure, any limitations arising on account of the same are not intended. As would be apparent to a person in the art, various working modifications may be made to the method in order to implement the inventive concept as taught herein.

We claim:

1. An apparatus for eliminating electricity leakage from an electronic device connected to a power supply, while the electronic device is in switched-off state or stand-by state, wherein the electricity leakage is the electricity consumed by at least one active component of the electronic device which remains active in the switched-off state or standby state, the apparatus comprising:
a charging module connected to at least one rechargeable battery for selectively providing electricity from the power supply to the rechargeable battery while the electronic device is in a switched-on state;
an isolation module configured to isolate the power supply from the electronic device while the electronic device is in the switched-off state or standby state and restore the power supply when the electronic device is in the switched-on state; and
a back up module connected to the rechargeable battery for providing the power to the at least one active component from the rechargeable battery such that at least one active component remains operational even when the electronic device is in switched-off state or standby state.

2. The apparatus as claimed in claim 1 wherein the isolation module comprises of a diode configured to disconnect the power supply from the electronic device when the electronic device is in switched-off state or standby state.

3. The apparatus as claimed in claim 1 wherein the active components are a remote control receiver and a real time clock.

4. The apparatus as claimed in claim 1 further comprising a behavior scheduling module configured for smart scheduling of the electronic device such that the electronic device learns the utilization behavior or habits of an user and generate a scheduling configuration to schedule powering up of the electronic device prior to scheduled use.

5. The apparatus as claimed in claim 1 wherein a plurality of components needed for working of the electronic device are active when the electronic device is in switched-on state.

6. The apparatus as claimed in claim 1 wherein the charging module is configured for charging the rechargeable battery through the power supply in a switched-off state or standby state, if the charge of the rechargeable battery is below a predefined threshold.

7. The apparatus as claimed in claim 1 wherein the charging module is configured for disconnecting the charging of the rechargeable battery in a switched-on state or switched-off state or standby state, once the rechargeable battery are completely charged.

8. The apparatus as claimed in claim 1 wherein the electronic device correspond to a group of appliances such as microwave ovens, coffee makers, TVs, DVRs, receivers, modems, wireless routers, cable boxes, satellite receivers and other electronic devices that consume electricity while in standby state and electronic devices such as cellular phones, smart phones, personal digital assistants (PDAs), mobile paging devices, mobile gaming devices, net books, net pads, laptops, or other computer devices that utilize a rechargeable battery and battery charger and or a remote controller to recharge the electronic device battery when its battery is exhausted to bring back to operational state.

9. The apparatus as claimed in claim 1 further comprising a charging controller, such that the charging controller comprises a timing and control IC for charging the electronic device based on one or more pre-specified protocols.

10. The apparatus as claimed in claim 1 wherein the pre-specified protocols are first initial charge, normal charge or quick charge.

11. The apparatus as claimed in claim 1 wherein the charging controller is configured to receive power from the rechargeable battery via a diode.

12. The apparatus as claimed in claim 1 wherein the charging controller comprises of a Microprocessor Unit (MPU), a Memory Module, a RAM Module, a Charging Protocol Table, Analog to Digital Module (A/D), an On/Off Switching Module and an Input/Output Module.

13. The apparatus as claimed in claim 12 wherein the Microprocessor Unit is configured to access a charging code of the rechargeable battery from the electronic device or/and the rechargeable battery and uses the charging protocol processed by RAM and MEMORY module.

14. The apparatus as claimed in claim 12 wherein the analog to digital module is configured for sensing the input current of the charging voltage.

15. The apparatus as claimed in claim 12 wherein the ON/OFF switching module is configured to automatically turn a charging electronic device ON/OFF.

16. The apparatus as claimed in claim 12 wherein the I/O module is configured to communicate with electronic device undercharged to use its transceiver for over the air communication for software update.

17. A method for eliminating electricity leakage from an electronic device connected to a power supply while the electronic device is in switched-off state or stand-by state, the electricity leakage is the electricity consumed by at least one active component of the electronic device which remains active in the switched-off state or standby state, the method comprising step of:
isolating the power supply from the electronic device when the electronic device is in switched-off state or standby state;
providing power to at least one active component of the electronic device from at least one rechargeable battery such that at least one active component remains operational even when the electronic device is in switched-off state or standby state; and charging the rechargeable battery from the power supply as the electronic device is in switched-on state.

18. A method as claimed in claim 17 further comprising restoring the power supply when the electronic device is switched-on state.

19. A method as claimed in claim 17 further comprising monitoring and controlling the charging of rechargeable batteries through a charging controller.

20. A method as claimed in claim 17 further comprising smart scheduling of the electronic device such that the electronic device learns the utilization behavior or habits of an user and generating a scheduling configuration to schedule powering up of the electronic device prior scheduled use.
